(19) United States
(12) Patent Application Publication
(10) Pub. No.: US 2003/0002745 A1
(43) Pub. Date: Jan. 2, 2003

(54) Method for enhancing scanned image output quality

(76) Inventors: James E. O'Hara, Boise, ID (US); Craig L. Miller, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/894,688

(22) Filed: Jun. 27, 2001

(51) Int. Cl. H04N 1/409; G06T 5/00; G06K 9/40; G06T 5/50; H04N 1/04

(52) U.S. Cl. 382/254; 382/275; 358/3.26; 382/318; 358/474

(57) ABSTRACT

A method for enhancing scanned image output quality including the steps of scanning a first side of an image bearing media to acquire first side image data representative of a first side image and scanning a second side of the image bearing media to acquire second side image data representative of a second side image. A processing device operable in connection with a scanning device utilizes second side image data in processing first side image data to enhance the quality of the image output.

### FIELD OF THE INVENTION

The present invention relates generally to the reduction of image defects in image processing and more specifically to a method for reducing image defects in a processed image attributable to the effect of backside image bleed through in two-sided documents.

### BACKGROUND OF THE INVENTION

Optical scanning and copying devices employ a method wherein data representative of a scanned object is produced by projecting an image of the scanned object onto an optical sensor. An image of the scanned object is projected onto an optical sensor by linear increment employing a moving scan line. The moving scan line is produced either by moving an image bearing media with respect to the scanner optical assembly or by moving the scanner optical assembly relative to an image bearing media. The optical sensor produces data representative of the intensity of the light projected thereon, i.e. data representative of the scanned image. Such stored data may be processed by a processing device to produce an image output or display. When photographic media is scanned to produce data representative of an image formed on that photographic media, the data may be further processed for output by an processing device.

Scanning devices may include a media input, a media transport assembly and a media feed path for transporting documents to a scan position, such as a flatbed platen, or across a scanline. Optical scanning devices also include an imaging assembly including an array of photosensitive sensors, operable in successive sampling intervals for generating a plurality of linear samplings producing image data representative of the object being scanned. Scanning devices are known that include both one or two imaging assemblies. In the case of a scanning device including a single imaging assembly, a single side of an object may be scanned at a time. In the case of a scanning device including a pair of imaging assemblies, both sides of an object may be scanned simultaneously. A document including images on both the first and second sides may be scanned simultaneously while being advanced through a scan position by the media transport.

A scanning device may be configured as a duplex scanning device which permits the substantially simultaneous scanning of first and second sides of an image bearing media for first and second side image data. One problem encountered in duplex scanning is an effect referred to as “bleed through”. Second side imagery may be captured or acquired when scanning the first side of the image bearing media and similarly, first side imagery may be captured or acquired when scanning the second side of the image bearing media. Upon output, for example as a printed document, bleed through data may be evidenced as a loss or degradation of output quality.

One method for reducing the effect of bleed through is to reduce the opacity of the image bearing media. Another method for reducing the effect of bleed through in duplex scanning has been to offset the first and second or upper and lower imaging assemblies, particularly the illumination and photo sensing elements of the first and second imaging assemblies, to reduce the capture or acquisition of bleed through image data.

### SUMMARY OF THE INVENTION

The present invention is directed to an image processing method for enhancing scanned image output quality including the steps of scanning a first side of an image bearing media to acquire first side image data representative of a first side image. The second side of the image bearing media is scanned to acquire second side image data which is representative of a second side image. The method of the present invention employs the second side image data to enhance image output quality of the first side image data.

Second side image data is mapped and utilized to reduce or eliminate first side bleed through data and distinguish first side bleed through data from first side image data. First side image data is compared to second side image data and first side bleed through data which coordinates with second side image data is subtracted from the image output data thereby enhancing image output quality of the first side image data and reducing image defects in a processed image attributable to the effect of image bleed through in two-sided documents.

Similarly, first side image data is mapped and utilized to reduce or eliminate second side bleed through data and distinguish second side bleed through data from second side image data. Second side image data is compared to first side image data and second side bleed through data which coordinates with first side image data is subtracted from the image output data thereby enhancing image output quality of the second side image data and reducing image defects in a processed image attributable to the effect of image bleed through in two-sided documents.

Mapping bleed through image data includes acquisition of opposing side image data and acquisition of data relating to the relative location of the opposing side image data. Once the bleed through image data is mapped, it is compared to primary image data. Data contained in the primary image data that corresponds to bleed through image data is removed from primary image data thereby enhancing image output data attributable to bleed through, image output data can be enhanced and the effects of bleed through minimized or eliminated.

### DESCRIPTION OF THE DRAWINGS

FIG. 1 is a schematic diagram illustrating the method for enhancing scanned image output quality according to the present invention;

FIG. 2 is a side cutaway view of a duplex scanning device including an automatic document feeder;

FIG. 3 is a side cutaway view of a duplex imaging assembly;

FIG. 4 is a block diagram illustrating a scanning device according to the present invention; and

FIG. 5 is a flow chart depicting the steps of a method for enhancing scanned image output quality according to the present invention.

### DETAILED DESCRIPTION OF THE INVENTION

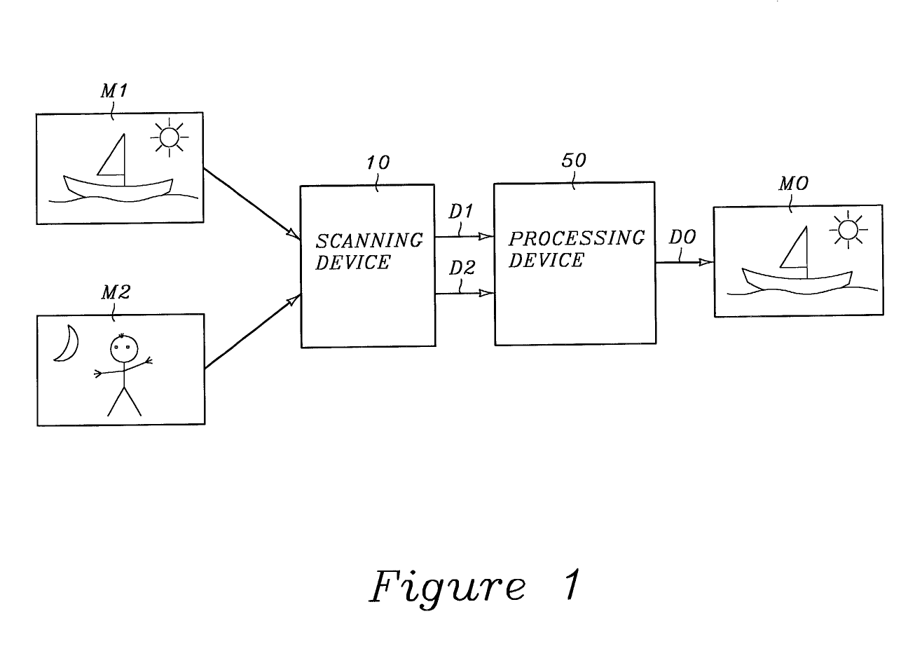

FIG. 1 is a schematic diagram illustrating a method for enhancing scanned image output quality according to the present invention. Media first side M1 and media second side M2 each include an image which is scanned by scanning device 10. Scanning media first side M1 produces first side image data D1 and scanning media second side M2 produces second side image data D2. Processing device 50 maps second side image data D2. Output data DO has been enhanced by the reduction of mapped second side image data D2 from first side image data D1. Enhanced output data DO may be replicated on output media MO. Alternately output data DO may be stored or output by other means, for example video output.

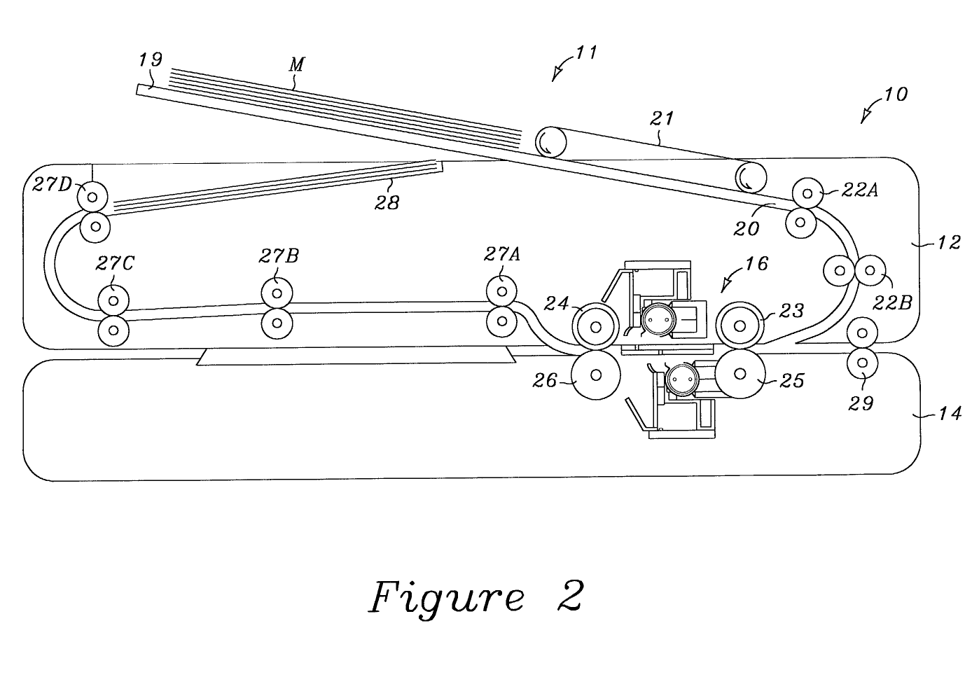

FIG. 2 is a side cutaway view of a duplex scanning device 10 including upper frame member 12 and lower frame member 14. Duplex scanning device 10 includes automatic document feeder 11 having input feed mechanism 21. Media M for processing are positioned in input tray 19. Input feed mechanism 21 transports media M along sheet transport path 20 where it is picked up by input feed rollers 22A and 22B. Alternately, media M may enter sheet transport path 20 at inline feed rollers 29. Sheet transport path 20 continues through duplex imaging assembly 16 by operation of first drive roll 23, second drive roll 24, first idler roll 25 and second idler roll 26.

Following scanning by duplex imaging assembly 16, media M continues along sheet transport path 20 and is picked up and transported by output feed rollers 27A, 27B, 27C and 27D to output tray 28.

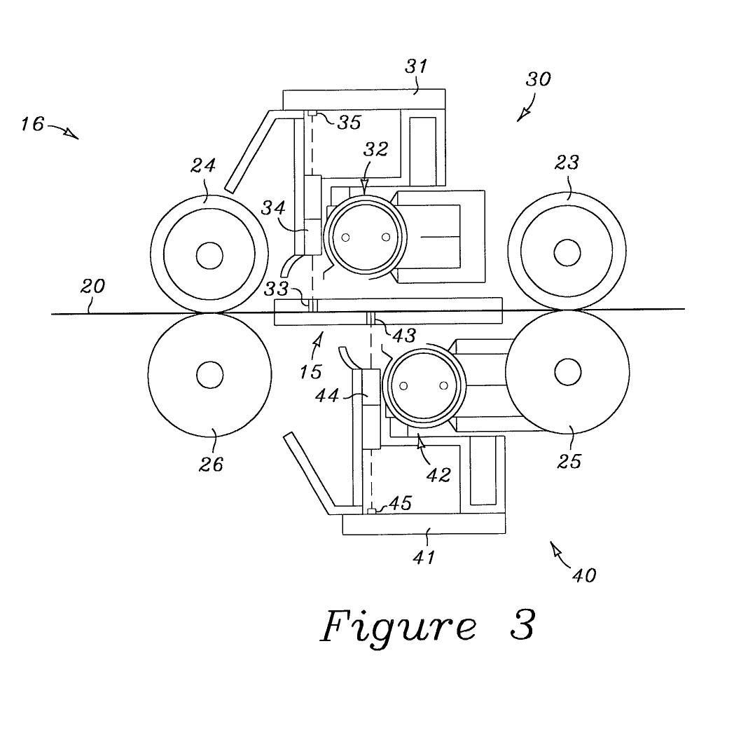

FIG. 3 is a side cutaway view of duplex imaging assembly 16. Sheet transport path 20 continues through duplex imaging assembly 16 by operation of first drive roll 23, second drive roll 24, first idler roll 25 and second idler roll 26. A first side of media M is scanned at scan location 15 by upper imaging assembly 30 and a second side of media M is scanned by lower imaging assembly 40.

Upper imaging assembly 30 includes upper imaging assembly frame 31 which supports upper lamp assembly 32 for illuminating a media first side scanline. Upper aperture 33 provides a light path for light reflected from the first side of media M through upper lens 34 to upper photo sensor 35. Data representative of the intensity of light which is reflected by the illuminated first side of media M is generated by upper photo sensor 35. Similarly, lower imaging assembly 40 includes lower imaging assembly frame 41 which supports lower lamp assembly 42 for illuminating a media second side scanline. Lower aperture 43 provides a light path for light reflected from the media second side scanline through lower lens 44 to lower photo sensor 45. Data representative of the intensity of light which is reflected by the illuminated second side of media M is generated by lower photo sensor 45.

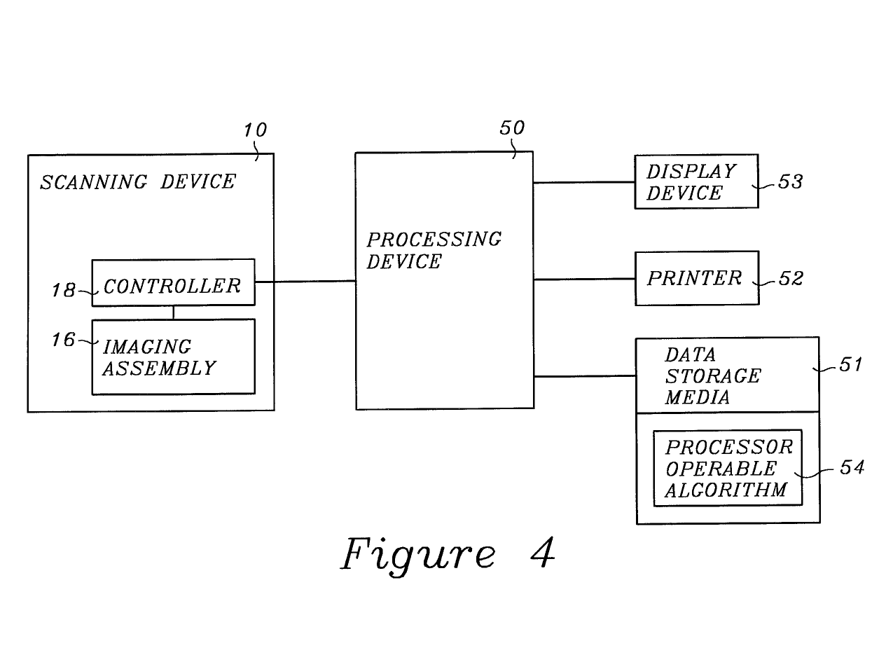

FIG. 4 is a block diagram illustrating a scanning device according to the present invention. As seen in FIG. 4, optical scanning device 10 may also include or may be connected to a processing device 50, for example a personal computer, for processing data from upper photo sensor 35 and lower photo sensor 45. One arrangement includes scanning device 10 including imaging assembly 16 connected to controller 18, controller 18 connected to processing device 50. Processing device 50 is connected to controller 18, data storage media 51, printer 52 and display device 53. Data storage media 51 may include processor operable algorithm 54 for removing bleed through image data from primary image data thereby enhancing image output quality.

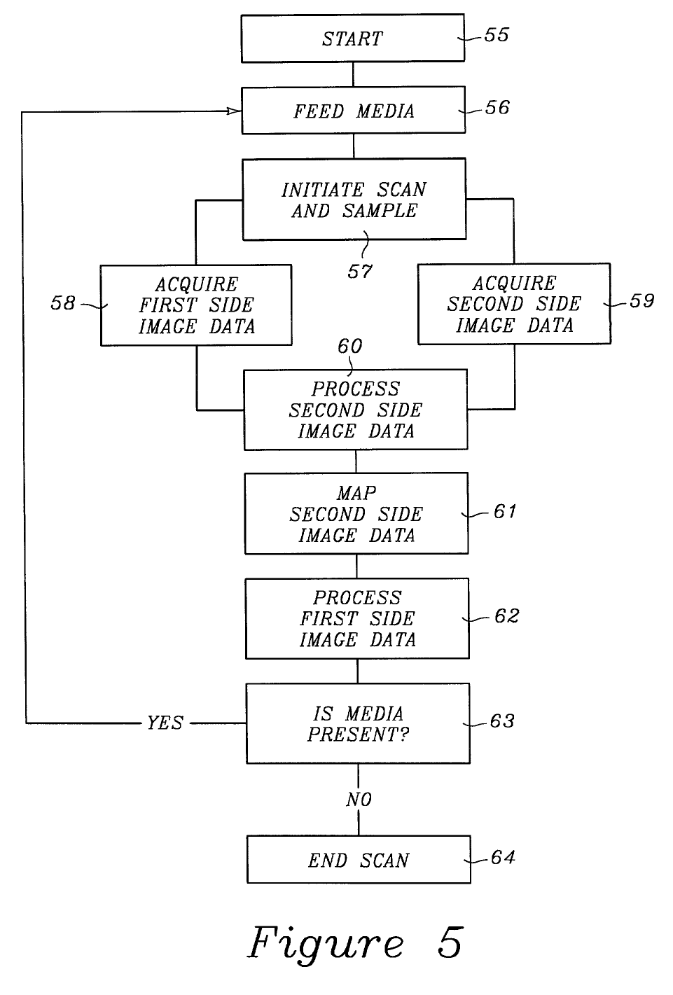

FIG. 5 is a flow chart depicting the steps of enhancing scanned image output quality by means of the present invention. The process is initiated at START 55. Media is fed by automatic document feeder 11, (shown in FIG. 2), at FEED MEDIA 56. Controller 18, (shown in FIG. 4), senses the presence of media and signals upper imaging assembly 30 and lower imaging assembly 40, (shown in FIG. 3), to initiate the scanning and sampling process at INITIATE SCAN AND SAMPLE 57. Upper photo sensor 35, (shown in FIG. 3), acquires data representative of light reflected by the media first side at ACQUIRE FIRST SIDE IMAGE DATA 58. Similarly, lower photo sensor 45, (shown in FIG. 3), acquires data representative of light reflected by the media second side at ACQUIRE SECOND SIDE IMAGE DATA 59. Second side image data D2, (shown in FIG. 1), is processed by processing device 50 at PROCESS SECOND SIDE IMAGE DATA 60. Second side image data is mapped at MAP SECOND SIDE IMAGE DATA 61 and second side image data is employed by processing device 50 to process and enhance first side image data D1 at PROCESS FIRST SIDE IMAGE DATA 62. Following processing of first side image data the process queries whether or not additional media is present at IS MEDIA PRESENT? 63. If media is present as indicated at YES, the process returns to FEED MEDIA at 56. If media is not present, as indicated at NO, the process ends the scan operation at END SCAN 64.

While this invention has been described with reference to the detailed embodiments, this is not meant to be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

What is claimed is:

1. An image data processing method for enhancing image output quality including the steps of:
scanning a first side of an image bearing media to acquire first side image data representative of a first side image;
scanning a second side of the image bearing media to acquire second side image data representative of a second side image;
mapping the second side image data; and
processing the first side image data deducting mapped second side image data from first side image data to enhance first side image output quality.

2. A scanning device for producing machine-readable data representative of an image bearing media comprising: a scanner controller;
a transport assembly connected to the scanner controller for moving a scanline relative to the image bearing media;
a first imaging assembly connected to the scanner controller and operable for acquiring first side image data;
a second imaging assembly connected to the scanner controller and operable for acquiring second side image data;
a processing device connected to the scanner controller;
a data storage media connected to the processing device; and
a data mapping algorithm operable by the processing device (50) to map the second side image data and deduct mapped second side image data from first side image data to enhance first side image output quality.
